(19) United States
(12) Patent Application Publication
(10) Pub. No.: US 2023/0071416 A1
(43) Pub. Date: Mar. 9, 2023

(54) APPARATUS, METHODS, AND SYSTEMS FOR COVERING AN UNDERSIDE PORTION OF A VEHICLE FOR PREVENTING THEFT OF COMPONENTS

(71) Applicant: Donald Andruszkiewicz, Tamarac, FL (US)

(72) Inventor: Donald Andruszkiewicz, Tamarac, FL (US)

(21) Appl. No.: 17/467,806

(22) Filed: Sep. 7, 2021

(51) Int. Cl. B60R 25/00

(52) U.S. Cl. CPC B60R 25/00

(57) ABSTRACT

A shield for covering a portion of an underside of a vehicle for preventing theft of components of the vehicle is disclosed. The shield includes a first section, a second section, and a third section. Each of the first, second, and third sections has a first end portion and a second end portion. The first section second end portion is in attachment with the second section first end portion, and the second section second end portion is in attachment with the third section first end portion. The first section and the third section are parallel. The shield has a lowered configuration where the shield receives a portion of a vehicle's wheels onto the third section. The weight of the vehicle applies a downward force onto the third section transitioning the shield into a raised configuration such that the first section covers a portion of the underside of the vehicle.

### CROSS-REFERENCE TO RELATED APPLICATIONS

Not applicable.

### STATEMENT REGARDING FEDERALLY SPONSORED RESEARCH OR DEVELOPMENT

Not applicable.

INCORPORATION BY REFERENCE OF MATERIAL SUBMITTED ON A COMPACT DISC

Not applicable.

### TECHNICAL FIELD

The present disclosure relates to the field of vehicle security, and more specifically to the field of shielding the underside of a vehicle to prevent theft.

### BACKGROUND

As the price of raw materials and precious metals rise, the risk of theft of certain components of a vehicle is greater. The most at-risk component of a vehicle is its catalytic converter, which is accessible from the undercarriage of a vehicle. The catalytic converter is often stolen by those looking to save money on repairs or to capitalize on the precious metals within the catalytic converter. The precious metals include palladium, rhodium, and platinum. The prices of which have been on a constant rise due to their high demand and limited global supply. For example, the price of palladium during the week of Apr. 30, 2012, reached approximately 670.48 per ounce and has since reached prices of approximately 2,993.60 per ounce as recorded the week of May 3, 2021, approximately a 446% growth since 2012. As of the time of this disclosure, the price of palladium is approximately 2,456.00 per ounce. The standard quantities of precious metals in the catalytic converter range from 3-7 grams of platinum, 2-7 grams of palladium, and 1-2 grams of rhodium. Depending on the make and model of the vehicle, the cost to replace a catalytic converter may range anywhere from approximately 900.00 to 2500.00.

The vehicle's most at-risk for theft are fleet vehicles which may include large pickup trucks and machinery. These fleet vehicles are vulnerable to theft because there is generally no security after working hours and on weekends, allowing thieves to steal the catalytic converters without worry. With the right equipment, a catalytic converter can be removed from a vehicle in under two minutes. If the catalytic converter is stolen, the owner is left with a vehicle inoperable for services costing the owner money for repairs and lost goods and services sold. The standard protection against theft is security cameras and storing the fleet vehicles behind a locked fence. Many thieves can either hop or break into the fenced in area, and if the theft occurs at night, it may be difficult to identify the culprit on camera without having an expensive security camera system.

Additionally, the gasoline tank is accessible from the undercarriage of the vehicle. Although less common, as the price of gasoline rises, theft of gasoline becomes more enticing to criminals. For example, a diesel truck with a thirty-three-gallon tank may be carrying approximately 110.00 worth of gasoline on a full tank, calculated at the national average price per gallon of diesel fuel at $3.35 at the time of this disclosure.

As a result, there exists a need for improvements over the prior art and more particularly for a more efficient way of preventing the theft of components from the underside of a vehicle.

### SUMMARY

An apparatus, systems, and methods for covering an underside portion of a vehicle for preventing theft of components is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a shield for covering a portion of an underside of a vehicle for preventing theft of components of the vehicle is disclosed. The shield includes first section, a second section, and a third section. Each section has a first end portion and a second end portion respectively. The first section second end portion is in attachment with the second section first end portion, and the second section second end portion is in attachment with the third section first end portion. A first angle is formed between the first section and the second section, and a second section is formed between the second section and the third section such that the first section and the third section are parallel.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown. A brief description of the figures are listed directly below.

FIG. 1 is a diagram of a first embodiment of a shield covering a portion of an underside of a vehicle for preventing theft of components of the vehicle, according to an example embodiment.

FIG. 2A is a side view of a second embodiment of the shield in a lowered configuration, according to an example embodiment.

FIG. 2B is a perspective view of the second embodiment of the shield in a raised configuration, according to an example embodiment.

FIG. 3A is a side view of a third embodiment of the shield in the lowered configuration, according to an example embodiment.

FIG. 3B is a perspective view of the third embodiment of the shield in the raised configuration, according to an example embodiment.

FIG. 4A is a side view of a fourth embodiment of the shield in the raised configuration, according to an example embodiment.

FIG. 4B is a perspective view of the fourth embodiment of the shield in the lowered configuration, according to an example embodiment.

FIG. 5A is a side view of a fifth embodiment of the shield in the lowered configuration, according to an example embodiment.

FIG. 5B is a perspective view of the fifth embodiment of the shield in the raised configuration, according to an example embodiment.

FIG. 6 is a side view of a sixth embodiment of the shield having a ridge on a third section, according to an example embodiment.

FIG. 7 is a perspective view of a seventh embodiment of the shield having a cut-out, according to an example embodiment.

FIG. 8 is a perspective view of an eight embodiment of the shield in the lowered configuration having the third section being wider than each of the first section and the second section, according to an example embodiment.

FIG. 9 is a perspective view of a ninth embodiment of the shield in the lowered configuration having the ramp with the support element, according to an example embodiment.

FIG. 10 is a system for covering a portion of an underside of a vehicle for preventing theft of the vehicle, according to an example embodiment.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a shield for covering a portion of an underside of a vehicle for preventing theft of components of the vehicle. The shield improves upon the prior art by providing an easy-to-use protective device to deter theft of the underside components of a vehicle. The disclosure allows a vehicle to drive up the first section of the shield and onto the third section. The vehicle then displaces a downwards force onto the third section raising the first section against the underside of the vehicle. The shield improves upon the prior art by allowing the vehicle to drive on and park on the shield to protect its underside portion. The shield then covers any access to the underside of the vehicle including access to catalytic converters and gas tanks. Additionally, the disclosure improves upon the prior art by providing an affordable security system for commercial fleet vehicles.

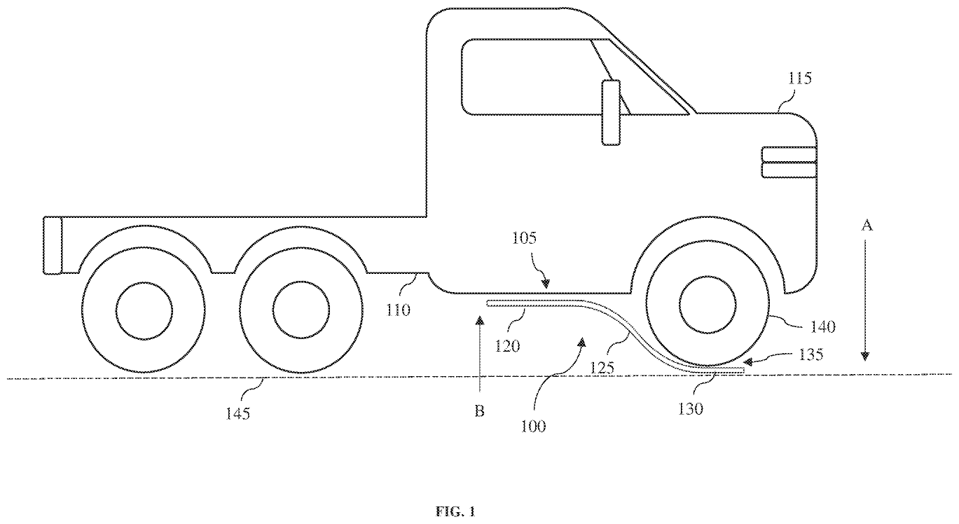

Referring now to the Figures, FIG. 1 is a diagram of shield 100 for covering a portion 105 of an underside 110 of a vehicle 115 for preventing theft of components of the vehicle, according to an example embodiment. The shield has a first section 120, a second section 125, and a third section 130. The first section is in attachment with the second section, and the second section is also in attachment with the third section.

The underside of a vehicle is generally the undercarriage which is located beneath the main body of the vehicle. The portion of the underside of the vehicle which the shield may be configured to cover depends on which components the user wants to protect from theft. For example, the portion of the underside may extend the entire length and width of the undercarriage of the vehicle in one embodiment. In another embodiment, the portion of the underside of the vehicle may be defined by dimensions of the components of the underside of the vehicle. Components of the vehicle may include the catalytic converter, gas tank, exhaust, oil, and battery. However, other components accessible from the underside of a vehicle are within the spirit and scope of the present disclosure.

Ideally, the shield has a plurality of dimensions configured for covering the portion of the underside of the vehicle that includes the point of access to the vehicle's catalytic converter. In other embodiments, the shield may be configured for covering a portion of the underside of the vehicle including the gasoline tank. The first section specifically has a plurality of dimensions configured for covering the portion of the underside of the vehicle. The plurality of dimensions may include at least a length, width, and thickness. The plurality of dimensions may vary to correspond with the dimensions of the portion of the underside of the vehicle. The first section may be of variable length and width to cover the desired portion of the underside of the vehicle. Depending on the materials and purpose, the thickness of the first section will vary. For example, a thicker first section may provide greater protection against theft and will provide more support to the first section to allow the vehicle to drive over the first section. A thin first section may allow the shield to be of lighter weight and cheaper to manufacture.

The second section defines a length such that the first section is at least proximal to and covers the portion of the underside of the vehicle when the third section second end portion is proximal to a ground surface. At least proximal to the portion of the underside of the vehicle means that the first section is a closer distance to the underside of the vehicle than it is to the ground. Likewise, the third section is proximal to the ground surface meaning it is a closer distance to the ground surface than it is to the underside portion of the vehicle. The ground surface may consist of any surface such as a paved road, driveway, dirt road, parking lot, garage floor, etc. However, other ground surfaces are within the spirit and scope of the disclosure.

The third section has a plurality of second dimensions for receiving a contact portion of a wheel of the vehicle. In certain embodiments, the third section has a width at least as wide as a wheel of a vehicle. The in other embodiments, the third section has a length and a width configured to receive a wheel of a vehicle such that the vehicle can drive onto the third section to apply a downward force onto the third section to move it proximal to the ground surface.

The shield has two configurations: a raised configuration and a lowered configuration. The raised configuration is such that the first section is proximal to and covers the portion of the underside of the vehicle when the third section second end portion is proximal to a ground surface. Contrarily, the lowered configuration is such that the first section is proximal to the ground surface and the third section is above the ground surface, specifically, the third section second end portion is above the ground surface. As illustrated in FIG. 1, the third section 130 is configured to receive a contact portion 135 of the wheel 140 of the vehicle 115. The weight of the vehicle applies a downward force in direction A acting on the third section. The downward force moves the third section proximate to the ground surface 145. Concurrently, the shield pivots about the intersection between the second section and the third section raising the first section in direction B the height of the underside of the vehicle to the ground surface so the first section is positioned proximate to the portion of the underside of the vehicle in the raised configuration.

The shield, including the first section, the second section, and the third section may include any material configured to shield a portion of the underside of a vehicle to prevent theft of components including carbon steel, stainless steel, aluminum, Titanium, other metals or alloys, wood, composites, ceramics, polymeric materials such as polycarbonates, such as Acrylonitrile butadiene styrene (ABS plastic), Lexan™, and Makrolon™. The shield may be formed from a single piece or from several individual pieces joined or coupled together. For example, the first section may be a solid plate in some embodiments. In other embodiments, the first section may be a wire or steel grate. The grate may be configured to allow a vehicle to drive on the shield while maintaining a lightweight yet protective structure. The components of the shield may be manufactured from a variety of different processes including an extrusion process, a mold, welding, shearing, punching welding, folding etc. However, other types of materials may also be used and are within the spirit and scope of the present disclosure.

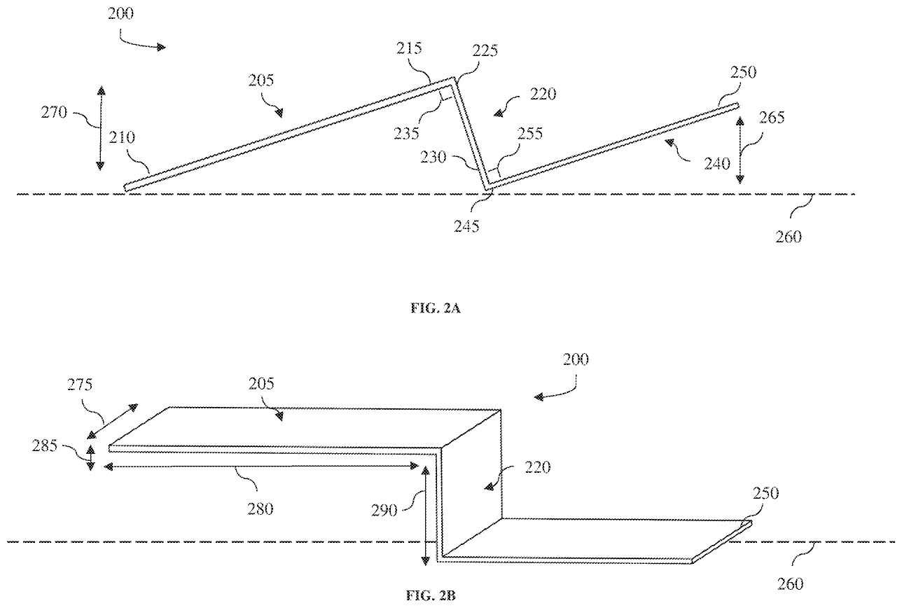

Referring now to FIG. 2A and FIG. 2B, the shield is shown according to an example embodiment. FIG. 2A is a side view of the shield in a lowered configuration, whereas FIG. 2B is a perspective view of the shield in a raised configuration. The shield 200 for covering a portion of an underside of a vehicle for preventing theft of components of the vehicle is shown. The shield has a first section 205 having a first section first end portion 210 and a first section second end portion 215. The shield also has a second section 220 having a second section first end portion 225 and a second section second end portion 230. The second section first end portion is in attachment with the first section second end portion. A first angle 235 is formed between the first section and the second section. The shield also has a third section 240 having a third section first end portion 245 and a third section second end portion 250. The third section first end portion is in attachment with the second section second end portion. A second angle 255 is formed between the second section and the third section. The first angle and the second angle are at least 90 degrees. In other embodiments, the first angle and the second angle are obtuse. The first angle allows the first second and the second section to form a ramp to allow a vehicle to drive onto the first section when the shield is in the lowered configuration. The lowered configuration is illustrated in FIG. 2A where the first section first end portion is proximate to the ground surface 260 and the third section second end section is above the ground surface. The first angle allows the downward force of the vehicle to be distributed to the second section second end portion creating a truss with the ground surface. The first section defines a ramp in the lowered configuration. In certain embodiments, the first angle and the second angle are equal such that the first section and the second section are parallel. Being parallel allows the first section first end portion to raise a distance to cover the portion of the underside of the vehicle where such distance is equivalent to the distance between the underside of the vehicle and the ground. In embodiments, where the first angle and the second angle are 90 degrees, the first section first end portion raises a distance equal to the length of the second section. In embodiments where the first section and the third section have an equivalent length, the first section first end portion raises a distance to the underside of the vehicle equal to the distance that the third section second end portion is above the ground surface. Other embodiments are within the spirit and scope of the disclosure such that the first section first end portion raises a distance to be proximate to the underside of the vehicle.

When the third section receives a portion of a wheel of the vehicle, the weight of the vehicle applies a downward force onto the third section causing the shield to pivot about the fulcrum of the shield where the second section second end portion and the third section first end portion are in attachment with one another. The downward force that the vehicle exerts onto the third section raises the first section, specifically, the first section first end portion, a second distance equal to the distance between the underside of the vehicle and the ground surface. The shield pivots upward to the raised configuration from the lowered configuration when said downward force acts on the third section. The distance 265 that the third section second end portion is above the ground surface in the lowered configuration should have a maximum height equal to the distance between the underside of the vehicle and the ground surface, otherwise, the third section may contact the underside of the vehicle. Ideally, the length of the third section has a minimum length at least sufficient to allow the wheels of the vehicle to rest on the third section where the vehicle exerts a downward force onto the third section. A shorter length of the third section equates to a shorter distance 265 that the third section second end portion is above the ground in the lowered configuration. The length of the third section, as measured from the third section first end portion to the third section second end portion, should not exceed a maximum length such that in the lowered configuration the third section second end portion is at rest at a distance greater than the distance between the underside portion of the vehicle and the ground surface.

In the raised configuration of FIG. 2B, the first section 205 is proximal to and covers the portion of the underside of the vehicle when the third section second end portion 250 is proximal to the ground surface. The first section has a plurality of dimensions (275, 280, 285) configured for covering the portion of the underside of the vehicle. The first section may have a width 275, a length 280, and a thickness 285. The plurality of dimensions is configured for covering the portion of the underside of the vehicle to protect the components of the vehicle. The second section has a length 290 being at least approximately the distance between the underside of the vehicle and the ground surface to prevent contact with the undercarriage. The second section first end portion is a height above the ground, in either the raised configuration or the lowered configuration, at most a distance approximately equal to the portion of the underside of the vehicle and the ground. When the second section is a length approximately the distance between the underside of the vehicle and the ground surface, then the first section is at least proximal to and covers the portion of the underside of the vehicle when the third section second end portion is proximal to the ground surface. When the first angle and the second angle are greater than 90 degrees, the length of the second section is at least approximately the distance between the underside portion of the vehicle and the ground surface. When the first angle and the second angle are 90 degrees, the length of the second section is at most approximately the distance between the underside portion of the vehicle and the ground surface because the second section will be vertical in the raised configuration. Therefore, the second section will have a length equal to the height of the second section first end portion above the ground surface. Approximately is defined to as a variance in the length configured to allow a clearance between the underside portion of the vehicle and the shield such that that shield does not make direct contact with the underside portion of the vehicle and the first section is proximate to the portion of the underside of the vehicle. In other embodiments, the second section has a length greater than the distance between the underside of the vehicle and the ground surface. In such an embodiment, the first angle and the second angle are obtuse angles greater than 90 degrees.

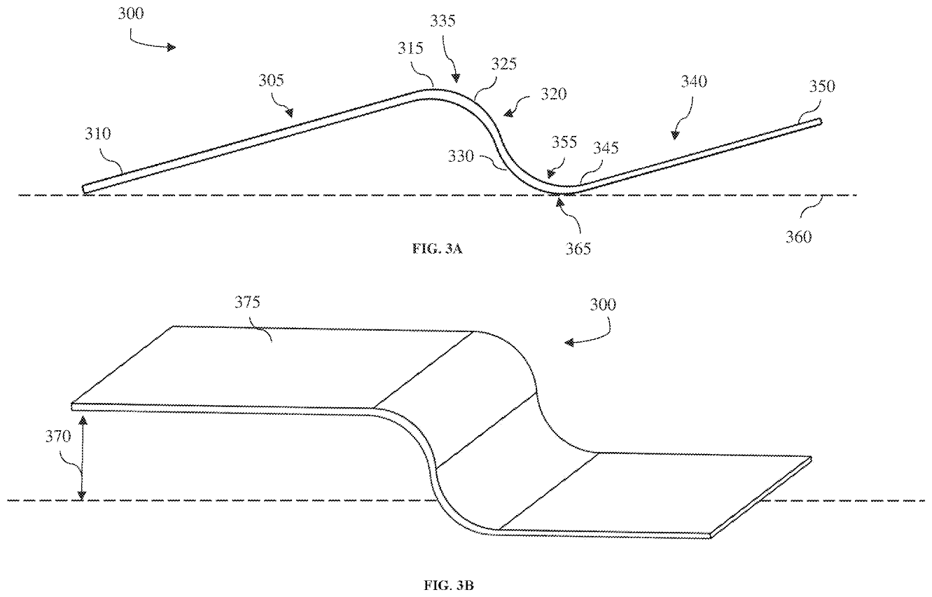

Referring now to FIG. 3A and FIG. 3B, the shield is shown according to an example embodiment. FIG. 3A is a side view of the shield in the lowered configuration, whereas FIG. 3B is a perspective view of the shield in the raised configuration. The shield 300 has the first section 305, the second section 320, and the third section 340. The first section second end portion 315 is in attachment with the second section first end portion 325. A curved section 335 is defined where the first section second end portion is in attachment with the second section first end portion. The curved section allows for a smooth transition between the first section and the second section thereby being configured to allow the vehicle to gradually move from the first section to the second section. Similarly, the second section second end portion 330 is in attachment with the third section first end portion 345. A curved section 355 is defined where the second section second end portion is in attachment with the third section first end portion. The curved section allows for a smooth transition between the second section and the third section thereby being configured to allow the vehicle to gradually move from the second section to the third section. Unlike a rigid section formed between the second section and the third section, a curved section is configured to receive the wheels of a vehicle thereby providing a more stable force directed towards the fulcrum 365 of the shield. Because the vehicle is no longer on the first section, the first section first end portion 310 does not support the weight of the vehicle. The downward force is the weight of the vehicle and is directed into the ground surface 360 at the fulcrum point between the second section second end portion and the third section first end portion. The vehicle then transitions onto the third section to move the shield between the lowered configuration to the raised configuration.

In the raised configuration, as illustrated in FIG. 3B, the third section has a plurality of second dimensions for receiving a contact portion of a wheel of the vehicle. The first section is raised a distance 370 which is a distance sufficient to allow a top surface 375 of the first section to position proximate to the portion of the underside of the vehicle. The first section is at least proximate to the portion of the underside of the vehicle to prevent theft of components. By being a close distance to the underside, thieves cannot access the underside components without severely damaging or breaking the shield. Therefore, the shield acts as at least a deterrent against the theft of the underside components.

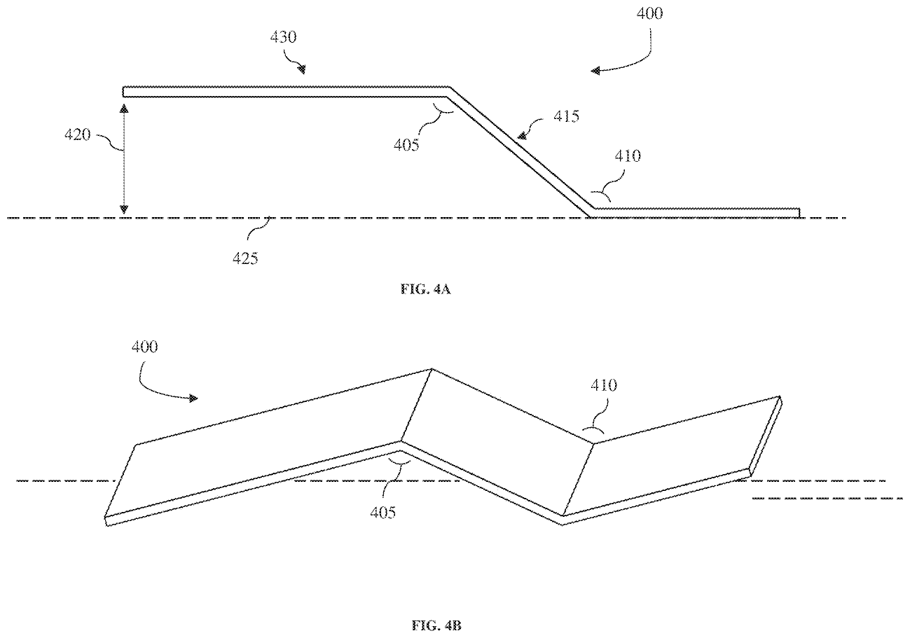

Referring now to FIG. 4A and FIG. 4B, the shield is shown according to an example embodiment. FIG. 4A is a side view of the shield in the raised configuration, whereas FIG. 4B is a perspective view of the shield in the lowered configuration, according to an example embodiment. The shield 400 is shown having the first angle 405 and the second angle 410 being greater than 90 degrees; thus, each of the first angle and the second angle is obtuse. In this embodiment, the length of the second section 415 is greater than the height 420 of the shield as measured from the ground surface 425 to the first section 430. In the raised configuration, the first section is parallel to the ground surface and the third section. Therefore, the first section will also be parallel to the underside of the vehicle when the first section is at least proximate to the portion of the underside of the vehicle in the raised configuration.

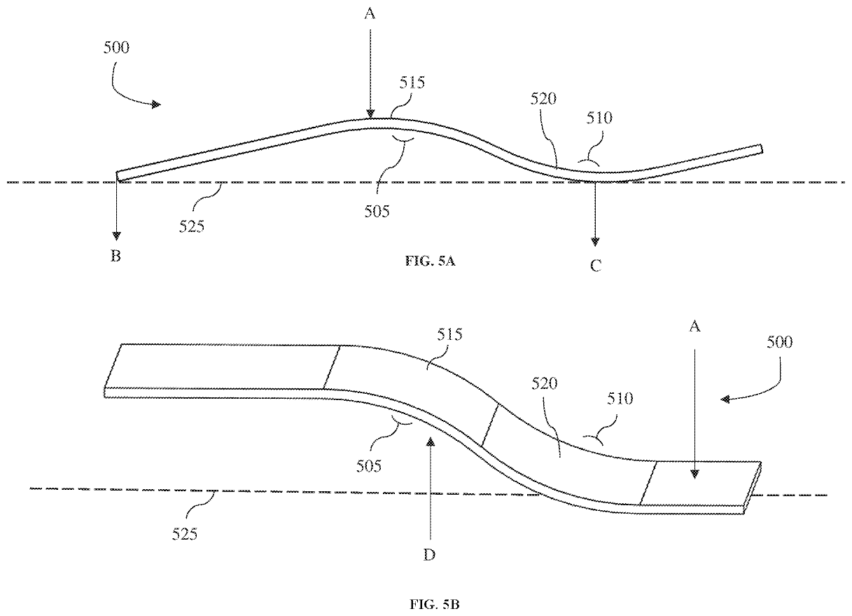

Referring now to FIG. 5A and FIG. 5B, the shield is shown according to an example embodiment. FIG. 5A is a side view of the shield in the lowered configuration, whereas FIG. 5B is a perspective view of the shield in the raised configuration. The shield 500 has the first angle 505 and the second angle 510 being obtuse angles. The angles are measured in relation the planes of the respective adjacent sections. At the first angle where the first section second end and the second section first end are in attachment, a first curved section 515 may be defined. The first curved section may have a downward concavity curving towards the ground surface 525. Referring specifically to the lowered configuration of FIG. 5A, the downward concavity of the first curve allows the downward force A, which is the weight of the vehicle, to be distributed to the first section first end portion and to the second section second end portion when the vehicle is driving over the shield in the lowered configuration. The weight of the vehicle is distributed to the ground at the first section first end portion as force B and into the ground surface at the second section second end portion as force C. At the second angle where the second section second end and the third section first end are in attachment, a second curved section 520 may be defined. The second curved section may have an upward concavity curving away from the ground surface. As the vehicle moves across from the first section of the shield to the third section of the shield, the downward force A action on the shield cause by the weight of the vehicle no longer acts on the first section.

Referring specifically to FIG. 5B, the downward force A is acting on the third section. The upward concavity of the second curve allows the shield to pivot about the curved section when the downward force A of the weight of the vehicle acts on the third section. The downward force acting on the third section pivots the shield into the raised configuration, where the first section is above the ground surface and proximate to the underside of the vehicle. While pivoting, an upward force D is a reaction force acting upward from the ground as a result of the downward force of the vehicle. The reaction force raises the first section proximate to the underside of the vehicle.

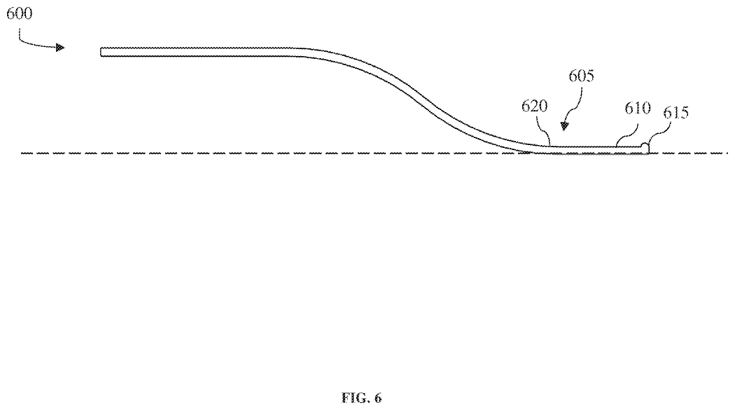

Referring now to FIG. 6, a side view of the shield having a ridge on a third section is shown, according to an example embodiment. The shield 600 may include a ridge 615 disposed on the third section 605 of the shield. The ridge is configured to prevent the shield from sliding out from underneath the vehicle. The ridge may also be configured to prevent the vehicle, specifically, the wheel of the vehicle, from rolling off the third section second end portion 610 of the shield. The ridge may be configured at such dimensions to allow the vehicle to drive over the ridge when the vehicle is in drive, but high enough to stop rolling motions of the wheel of the vehicle. The ridge will keep the shield in its desired place and configuration. It may also prevent thieves from being able to push the vehicle off the shield to access the components on the underside of the vehicle. Ideally, the ridge is disposed on the third section second end portion. In other embodiments, there may be multiple ridges 615 such that there is a ridge disposed on the third section first end portion 620 and the third section second end portion. The third section will receive a contact portion of the wheel of the vehicle between said ridges to retain the vehicle and the shield in the desired placement to cover a portion of the underside of the vehicle to prevent theft of its components thereof.

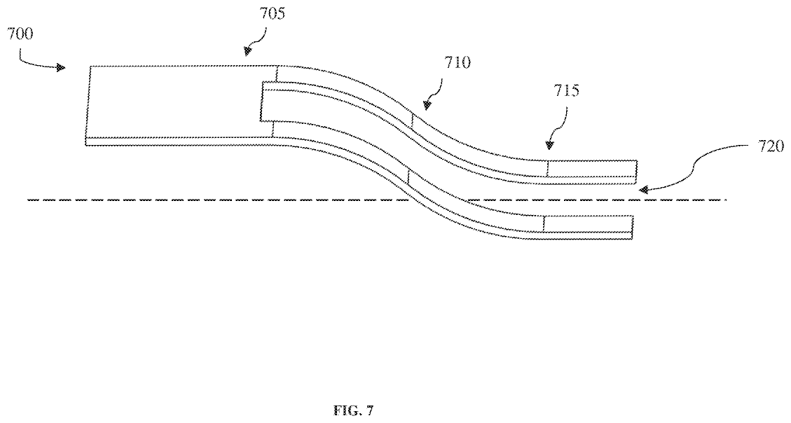

Referring now to FIG. 7, a perspective view of the shield 700 having a cut-out 720 is shown, according to an example embodiment. As illustrated, the cut-out is on the third section 715, second section 710, and the first section 705. The cutout is defined by a void of material in the shield. The cut-out, for example, may only be on the third section or second section for example such that the second section and third section are configured to receive the wheels of the vehicle. Each of the second section and third section is still at least wide enough to receive a portion of a wheel of a vehicle. The cut-out may be beneficial to reduce the weight of the shield and the amount of material used to manufacture the shield. The first section still retains a plurality of dimensions configured to cover a portion of the underside of the vehicle. The first section is always configured to cover a portion of the underside of the vehicle. Similarly, the third section always has a plurality of second dimensions configured to at least receive a portion of a wheel of a vehicle. The second section has a plurality of dimensions configured to raise the first section proximate to the underside portion of the vehicle such that the second section acts as a load arm of a lever. Depending on the embodiment, the second section may be configured to receive a portion of the wheel of the vehicle.

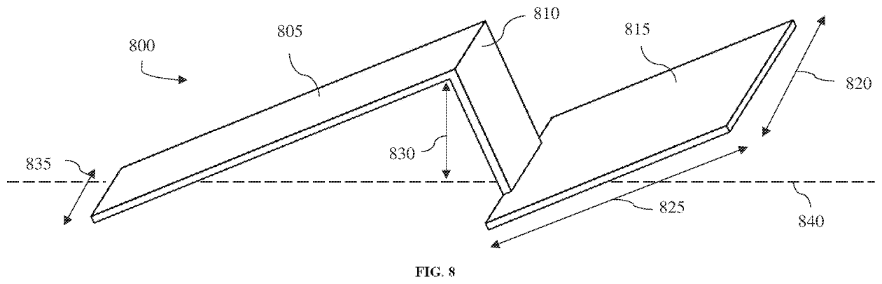

Referring now to FIG. 8, a perspective view of the shield 800 in the lowered configuration having the third section 815 being wider than each of the first section 805 and the second section 810 is shown, according to an example embodiment. The third section has a second plurality of dimensions (820, 825). In this example embodiment, the third section has a width 820 and a length 825. The width 820 is wider than the width 835 of the first section and the second section. In this embodiment, the width 835 has a maximum width equal to the distance between two coaxial wheels of the vehicle providing clearance to allow the vehicle to drive over the first section and the second section without contacting the either the first section or second section. The vehicle drives directly onto the third section because the width 825 is configured to receive a portion of the wheel to allow the vehicle to provide a downward force onto the third section to move it from the lowered configuration into the raised configuration. To drive over the first section and second section, the height 830, must be less than the height of the underside of the vehicle to the ground surface 840. The height 830 is measured from the point where the first section second end and the second section first end are in attachment with each other to the ground surface. The height being less than the distance to the underside portion of the vehicle provides clearance for the vehicle to drive over the shield without having the shield contact the underside of the vehicle.

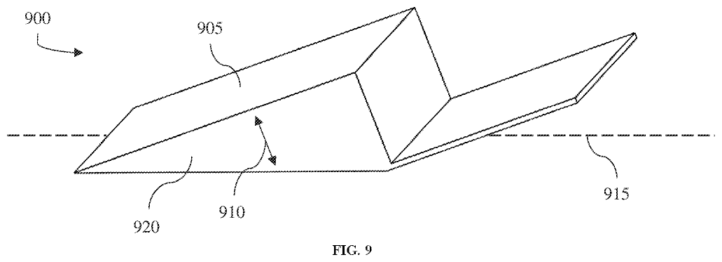

Referring now to FIG. 9 a perspective view of the shield in the lowered configuration having the ramp with the support element is shown, according to an example embodiment. The shield 900 has a first section 905 having a plurality of dimensions, including a thickness 910. In certain embodiments, the thickness may be a variable thickness, meaning that the thickness at the first section first end portion is a different thickness than the thickness at the first end second end portion. As illustrated, the thickness extends from the top surface of the first section to the ground surface 915 in the lowered configuration may define a support element 920. The support element provides the first section with additional support to be capable of supporting the weight of the vehicle in the lowered configuration. The support element may be a series of columns in attachment with the first section configured to contact the ground in the lowered configuration. The first section and the support element define a ramp where the first section first end portion is still capable of raising a distance equal to the distance between the underside portion of the vehicle and the ground.

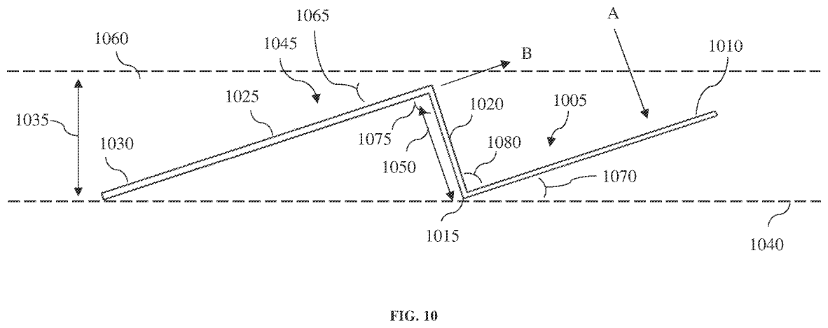

Referring now to FIG. 10, a system for covering a portion of an underside of a vehicle for preventing theft of the vehicle is shown, according to an example embodiment. The system includes a lever 1005 having an effort arm 1010, a fulcrum 1015, and a load arm 1020. The system also includes a ramp 1025 in attachment with the load arm of the lever. The ramp may include the first section in attachment with the second section. The load arm is generally the second section, and the effort arm is generally the third section. The point where the second section second end and the third section first end are in attachment defines the fulcrum. The fulcrum is the point at which the lever pivots about when the downward force of the weight of the vehicle acts on the effort arm. The fulcrum is always in contact with the ground surface despite whether the fulcrum is acting as support for the ramp to distribute the downward force of the weight of the vehicle into the ground surface 1040 in the lowered configuration or whether the fulcrum is the pivot point of the system when the downward force acts on the effort arm, or third section, to transition the system into the raised configuration. In certain embodiments the fulcrum is a curved section allowing the lever to gradually pivot. When the vehicle exerts a downward force on the effort arm of the lever, a first end portion 1030 of the ramp raises a distance 1035 equal to the distance between the underside 1060 of the vehicle and a ground surface such that an upward facing section 1045 of the ramp is proximate to the underside of the vehicle. The downward force acts in direction A on the effort arm of the lever corresponding to a force on the load arm in direction B pulling the ramp and thereby raising the first end portion of the ramp as the system pivots. Ideally, the ramp and the effort arm are parallel such that a third angle 1065 between ramp and the underside of the vehicle is the same as a fourth angle 1070 between the effort arm and the ground surface. Therefore, the distance the effort arm moves towards the ground surface, as a result of the downward force, corresponds to the degrees of rotation that the system pivots equal to the second angle; and the distance 1035 that the first portion of the ramp moves also corresponds to that same degree of rotation. Where the first angle between the second section and the third section is 90 degrees, the second section will rotate until the second section is vertical. In such an embodiment, the third angle 1065 and the fourth angle 1070 is at most 45 degrees. Any rotation about the fulcrum more than 45 degrees will result in the system contacting the underside portion of the vehicle.

The upward facing section may be defined by a top surface of the first section. The load arm has a length 1050 at least approximately equal to a distance between the underside of the vehicle and the ground surface. When the first angle 1075, formed between the ramp and the load arm, and the second angle 1080, formed between the load arm and the effort arm, are 90 degrees, then the length of the load arm 1050 is at most approximate to the distance 1035 of the underside of the vehicle to the ground surface. When the first angel and the second angle are obtuse angles, or greater than 90 degrees, then the length of the load arm 1050 is at least approximately the distance 1035 between the underside of the vehicle and the ground surface. The length of the load arm is configured at a length such that the ramp first end portion 1030 raises approximately the distance 1035 to position proximate to the underside portion of the vehicle and cover its underside components. The ramp has a ramp length equal to a portion length of the portion of the underside of the vehicle. The ramp also has a ramp width equal to a portion width of the portion of the underside of the vehicle. The ramp length and the ramp width correspond to the plurality of dimensions of the first section.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A shield for covering a portion of an underside of a vehicle for preventing theft of components of the vehicle comprising:
a first section having a first section first end portion and a first section second end portion;
a second section having a second section first end portion and a second section second end portion, wherein the second section first end portion is in attachment with the first section second end portion;
a first angle formed between the first section and the second section;
a third section having a third section first end portion and a third section second end portion, wherein the third section first end portion is in attachment with the second section second end portion;
a second angle formed between the second section and the third section; and
wherein the first section is parallel to the third section.

2. The shield of claim 1, wherein the first angle is at least 90 degrees, and the second angle is at least 90 degrees.

3. The shield of claim 2, wherein the first section having a plurality of dimensions configured for covering the portion of the underside of the vehicle.

4. The shield of claim 3, wherein the second section defines a length such that the first section is at least proximal to and covers the portion of the underside of the vehicle when the third section second end portion is proximal to a ground surface.

5. The shield of claim 4, wherein a curved section is defined where the second section second end portion is in attachment with the third section first end portion.

6. The shield of claim 5, wherein the third section having a plurality of second dimensions for receiving a contact portion of a wheel of the vehicle.

7. The shield of claim 6, wherein the third section comprises a ridge on the third section second end portion.

8. A system for covering a portion of an underside of a vehicle for preventing theft of components of the vehicle comprising:
a first section having a first section first end portion and a first section second end portion;
a second section having a second section first end portion and a second section second end portion, wherein the second section first end portion is in attachment with the first section second end portion;
a first angle formed between the first section and the second section;
a third section having a third section first end portion and a third section second end portion, wherein the third section first end portion is in attachment with the second section second end portion;
a second angle formed between the second section and the third section;
wherein the first section is parallel to the third section; and
a raised configuration such that the first section is proximal to and covers the portion of the underside of the vehicle when the third section second end portion is proximal to a ground surface.

9. The system of claim 8, wherein a curved section is defined where the second section second end portion is in attachment with the third section first end portion.

10. The system of claim 9, wherein in a lowered configuration the system is such that i) the first section first end portion is proximal to the ground surface, and ii) the third section second end portion is a distance above the ground surface.

11. The system of claim 10, wherein the first section pivots upward to the raised configuration from the lowered configuration when a downward force acts on the third section.

12. The system of claim 11, wherein the downward force is caused by a weigh of a vehicle.

13. The system of claim 12, wherein the distance above the ground surface is such that that when the vehicle exerts the downward force onto the third section the first section first end portion raises a second distance equal to the distance between the underside of the vehicle and the ground surface.

14. The system of claim 13, wherein the distance above the ground surface has a maximum distance equal to the distance between the underside of the vehicle and the ground surface.

15. A system for covering a portion of an underside of a vehicle for preventing theft of the vehicle comprising:
a lever having an effort arm, a fulcrum, and a load arm; and
a ramp in attachment with the load arm of the lever.

16. The system of claim 15, wherein the load arm has a length at least equal to a distance between the underside of the vehicle and a ground surface.

17. The system of claim 15, wherein the ramp has a ramp length equal to a portion length of the portion of the underside of the vehicle.

18. The system of claim 15, wherein the ramp has a ramp width equal to a portion width of the portion of the underside of the vehicle.

19. The system of claim 15, wherein when the vehicle exerts a downward force on the effort arm of the lever, a first end portion of the ramp raises a distance equal to the distance between the underside of the vehicle and a ground surface such that an upward facing section of the ramp is proximate to the underside of the vehicle.

20. The system of claim 15, wherein the fulcrum is a curved section in attachment with the load arm and the effort arm.
